(19) United States
(12) Patent Application Publication
(10) Pub. No.: US 2014/0032753 A1
(43) Pub. Date: Jan. 30, 2014

(54) COMPUTER SYSTEM AND NODE SEARCH METHOD

(71) Applicants: Kentaro Watanabe, Tokyo (JP); Yoshifumi Takamoto, Tokyo (JP); Takashi Tameshige, Tokyo (JP); Yujiro Ichikawa, Tokyo (JP)

(72) Inventors: Kentaro Watanabe, Tokyo (JP); Yoshifumi Takamoto, Tokyo (JP); Takashi Tameshige, Tokyo (JP); Yujiro Ichikawa, Tokyo (JP)

(73) Assignee: Hitachi, Ltd., Tokyo (JP)

(21) Appl. No.: 14/110,867

(22) PCT Filed: May 16, 2011
(86) PCT No.: PCT/JP2011/002717

§ 371 Date: Oct. 9, 2013

(51) Int. Cl. H04L 29/08

(52) U.S. Cl. CPC H04L 29/08549
USPC 709/224

(57) ABSTRACT

A computer system and node search method capable of reducing node discovery time in the computer system with a large number of nodes and a large number of supported protocols is proposed. The computer system includes a management server which is connected to each of first and second nodes via a network and collects and manages first information for each of the first and second nodes including network addresses of the first and second nodes and a protocol type of a communication protocol to be used when communicating with the first or second node. When the management server searches the first and second nodes over the network and detects the second node, it acquires the network address of each first node managed by the second node and the protocol type of the communication protocol to be used when communicating with the first node.

### TECHNICAL FIELD

The present invention relates to a network node management system and node search method and is suited for use in a computer system including, for example, a management server and a plurality of servers, and a node search method.

### BACKGROUND ART

Recently, networks have become indispensable for businesses. A computer system cooperating at a company's datacenter is provided with an administrator's node for managing nodes connected over a network and an administrator issues various operational instructions, for example, to power on/off to the nodes on the network. Therefore, the administrator of the computer system needs to recognize and manage what kinds of nodes are connected to the network, in what state and how the nodes are used, and what communication protocol type is used to access the nodes.

Meanwhile, an agent management system, according to which an information collection program (or agent) is mounted in a target node(s) to be managed and this program of the management target node collects node information on the network by periodically sending the node information about the node to the administrator's node, has been conventionally used as a method for collecting the node information about each node in the network. For example, Patent Literature 1 discloses a method for collecting the node information by using the agent management system on a network node system supported by two types of protocols.

### CITATION LIST

### Patent Literature

[Patent Literature 1] Japanese Patent Application Laid-Open (Kokai) Publication No. 2008-146410

### SUMMARY OF INVENTION

### Problems to be Solved by the Invention

Meanwhile, if the number of protocols supported by a computer system increases, the method disclosed in Patent Literature 1 mentioned above has problems of difficulties in collecting the node information depending on the number of protocols and increase of time required for processing because Patent Literature 1 uses a method of having an administrator examine whether the nodes can be accessed or not, sequentially with respect to one predefined protocol to another and acquiring the node information about the node(s) which has been successfully accessed.

Furthermore, if the number of target nodes to be managed on the computer system increases, the method disclosed in Patent Literature 1 mentioned above also has a problem of increase of time required for processing because a search range of the nodes which the administrator needs to examine expands according to the number of nodes.

Furthermore, Patent Literature 1 mentioned above discloses the method using the agent management system; however, recently, there has been a strong tendency to worry about maintenance complication of the agent program, a competitive problem between the agent program and the nodes, and time and effort required for installment of programs when adding a node, so that it has been becoming common to use an agentless management system that introduces a node information collection program to the administrator's node and enables the administrator's node to acquire the noted information via the network without activating the node information collection program at the target nodes to be managed. Therefore, there is a problem of the necessity to propose a method for collecting the node information in the network by using the agentless management system.

The present invention was devised in consideration of the above-described points and proposes a computer system and node search method capable of reducing node discovery time in the computer system with a large number of nodes and a large number of supported protocols.

### MEANS FOR SOLVING THE PROBLEMS

In order to solve the above-described problems, provided according to the present invention is a computer system including: a plurality of first nodes connected to a network; one or more second nodes which are connected to the network and manage part or all of the plurality of first nodes; and a management server which is connected to each of the first and second nodes via the network and collects and manages first information for each of the first and second nodes, including a network address of each of the first and second nodes and a protocol type of a communication protocol to be used when communicating with the first or second node, wherein the second node manages second information including a network address of each management target first node among the plurality of first nodes and a protocol type of a communication protocol to be used when communicating with the first node, and wherein when the management server searches the first and second nodes on the network and detects the second node, it acquires the network address of each of the first nodes managed by the second node and the protocol type of the communication protocol to be used when communicating with the first node, from the second node and manages the acquired network address and the acquired protocol type for each of the first nodes by associating them with each other.

Furthermore, provided according to the present invention is a node search method for a computer system including: a plurality of first nodes connected to a network; one or more second nodes which are connected to the network and manage part or all of the plurality of first nodes; and a management server which is connected to each of the first and second nodes via the network and collects and manages first information for each of the first and second nodes, including a network address of each of the first and second nodes and a protocol type of a communication protocol to be used when communicating with the first or second node, wherein the second node manages second information including a network address of each management target first node among the plurality of first nodes and a protocol type of a communication protocol to be used when communicating with the first node, and the node search method includes: a first step executed by the management server searching the first and second nodes on the network; and a second step executed by the management server, when detecting the second node, acquiring the network address of each of the first nodes managed by the second node and the protocol type of the communication protocol to be used when communicating with the first node, from the second node and managing the acquired network address and the acquired protocol type for each of the first nodes by associating them with each other.

### ADVANTAGEOUS EFFECTS OF INVENTION

According to the present invention, node discovery time can be reduced even with a computer system with a large number of nodes and a large number of supported protocols.

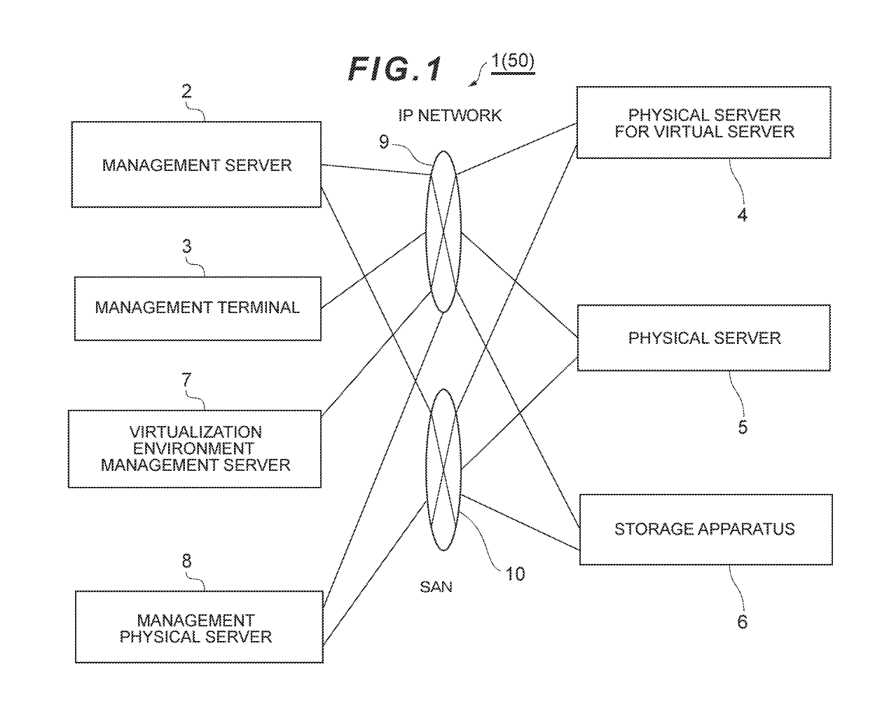

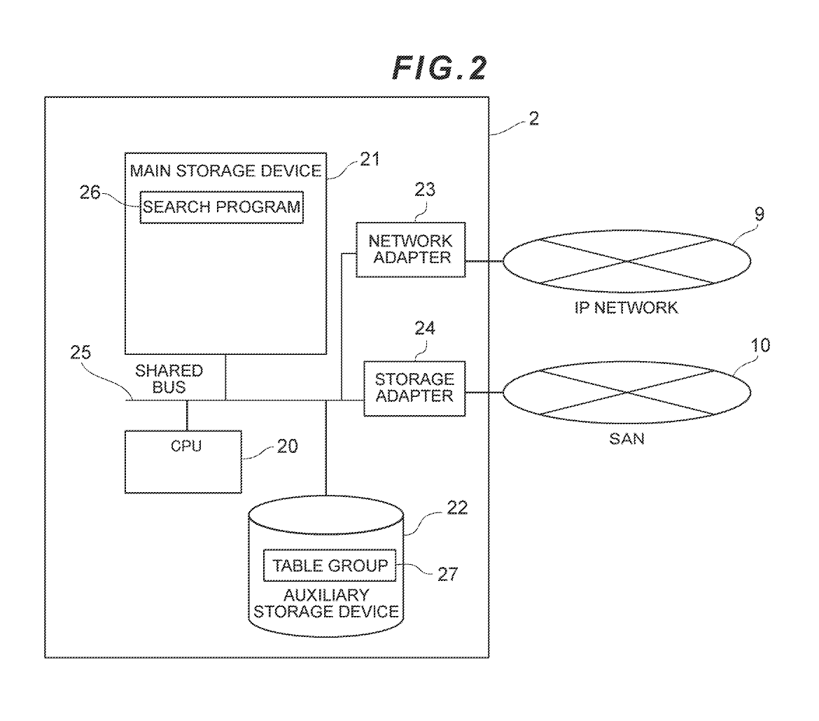

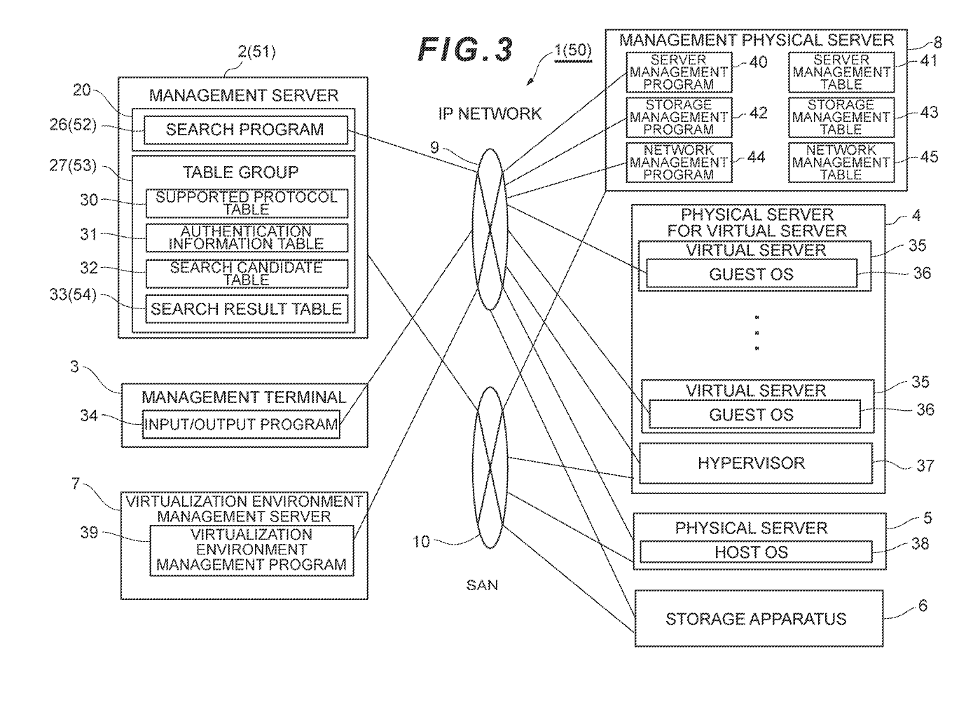

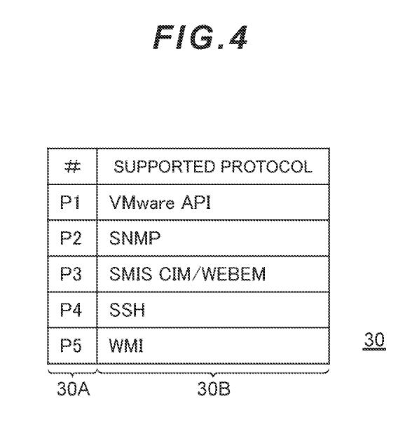

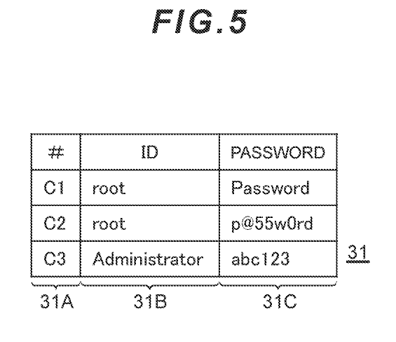

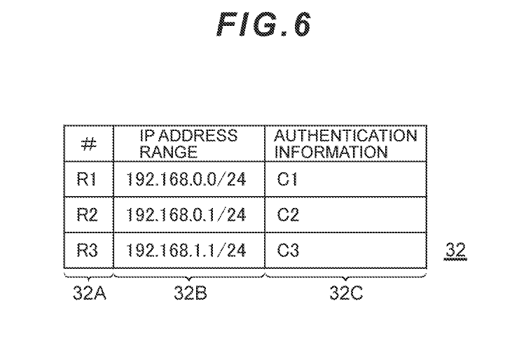

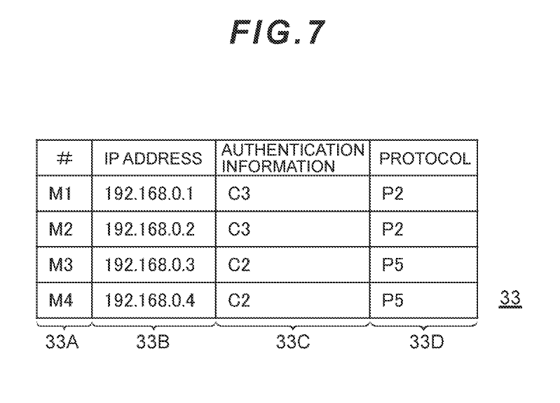

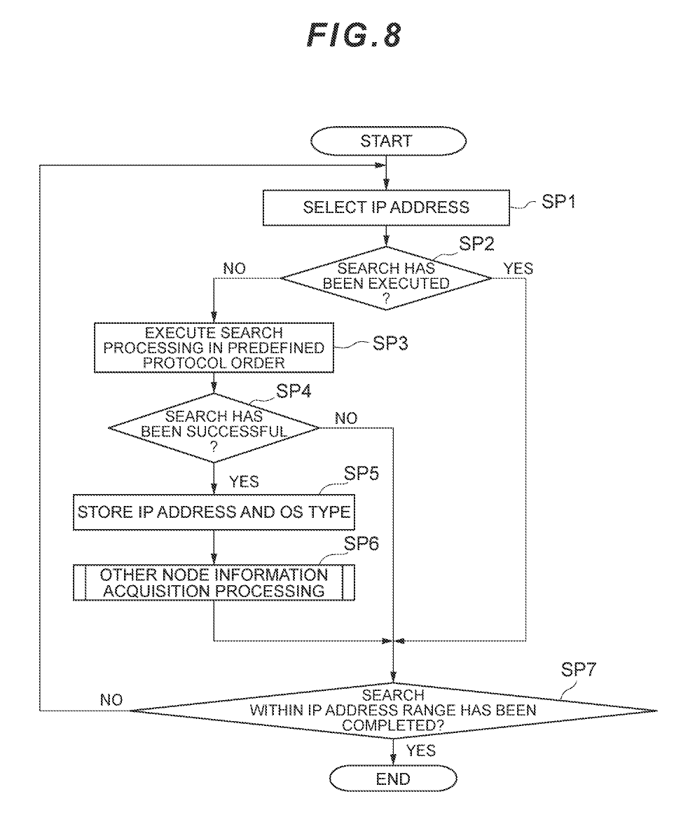

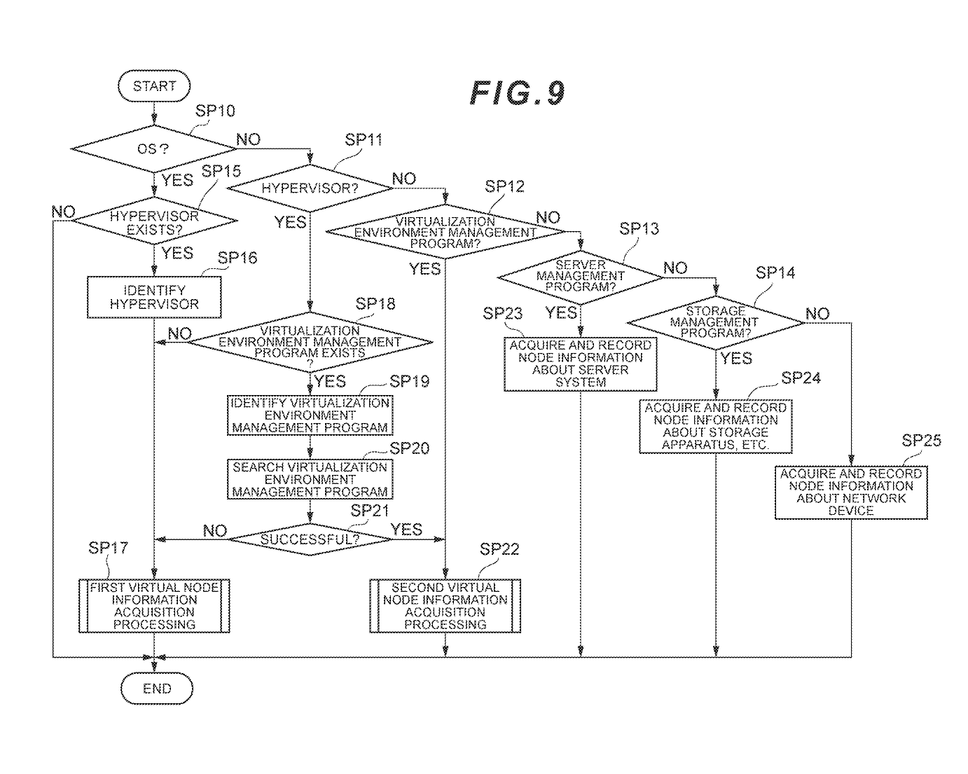

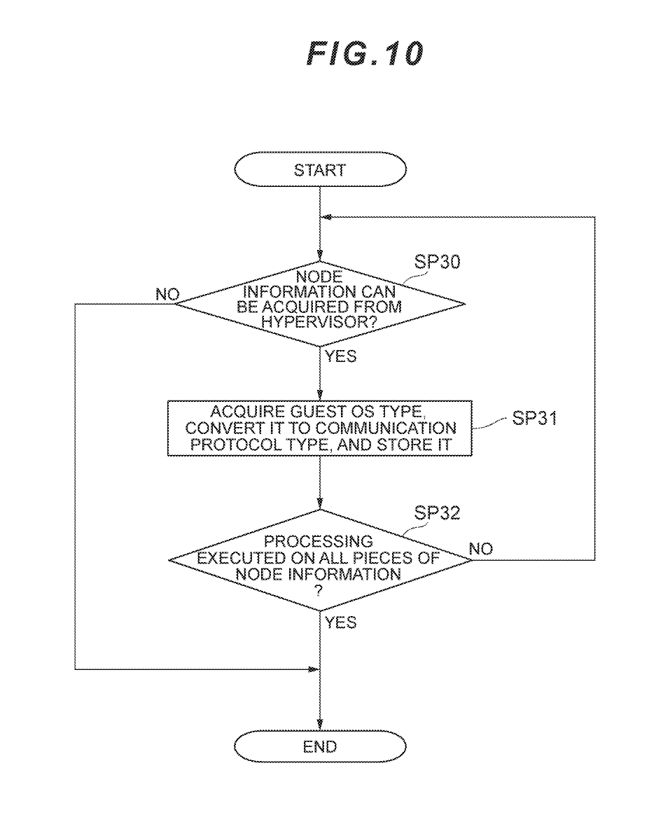

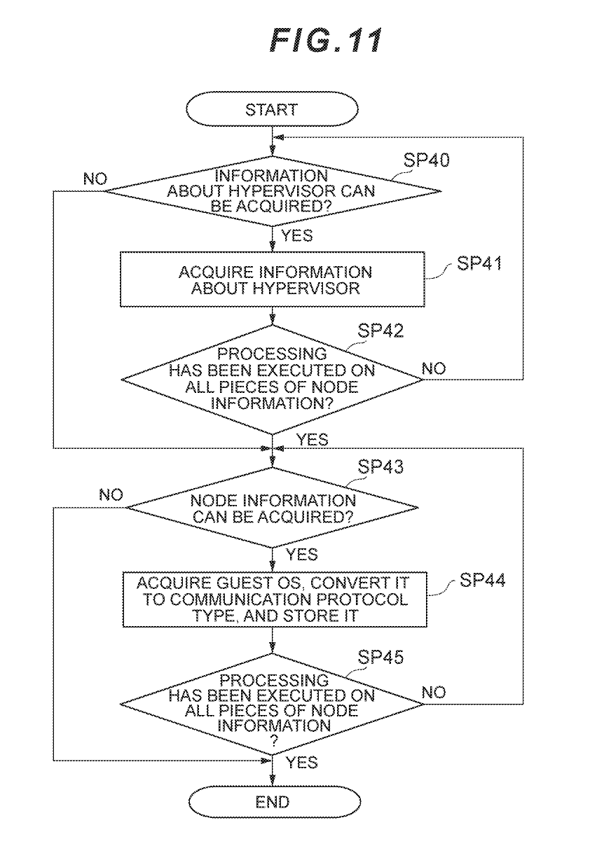

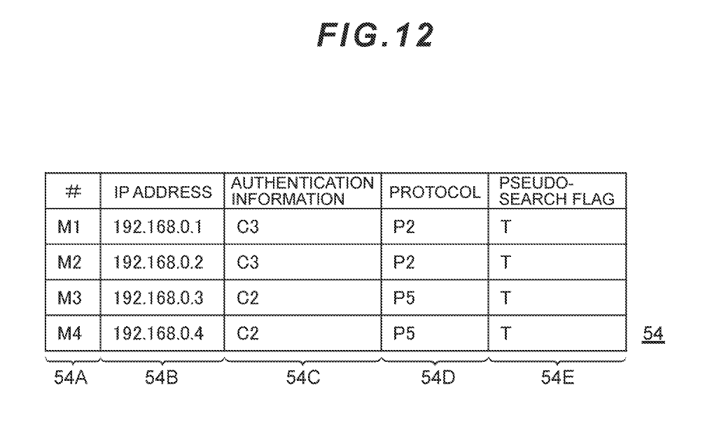

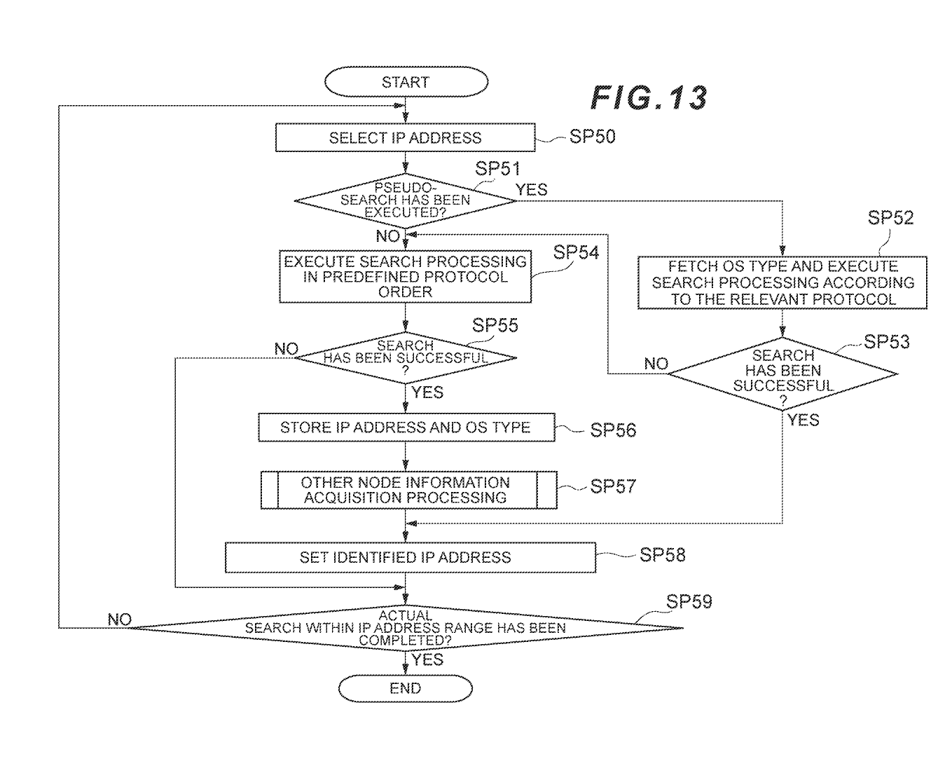

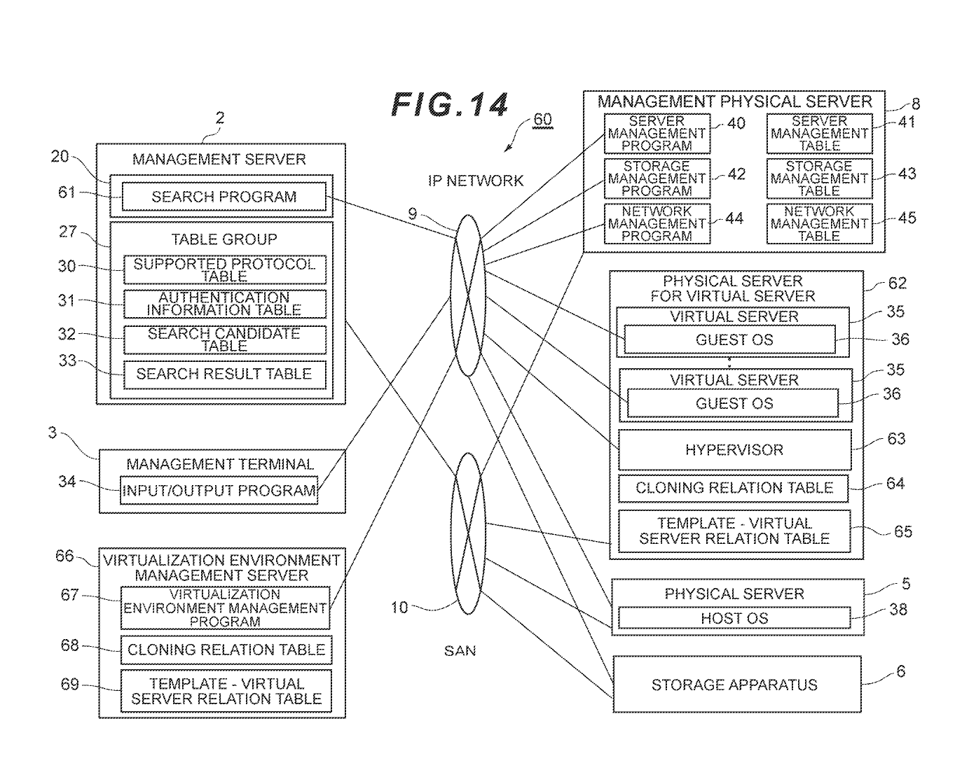

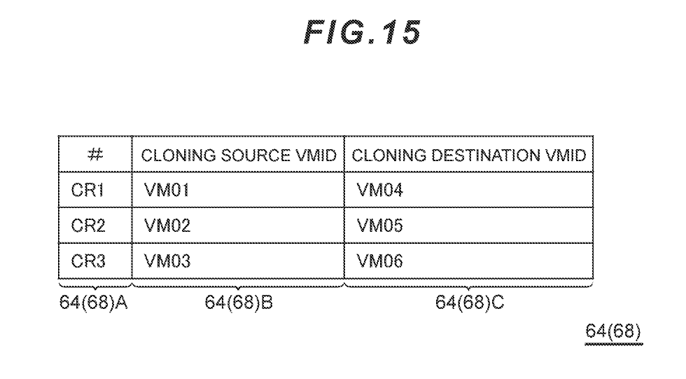

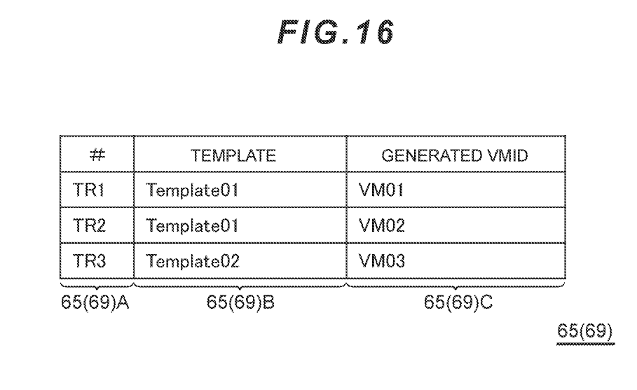

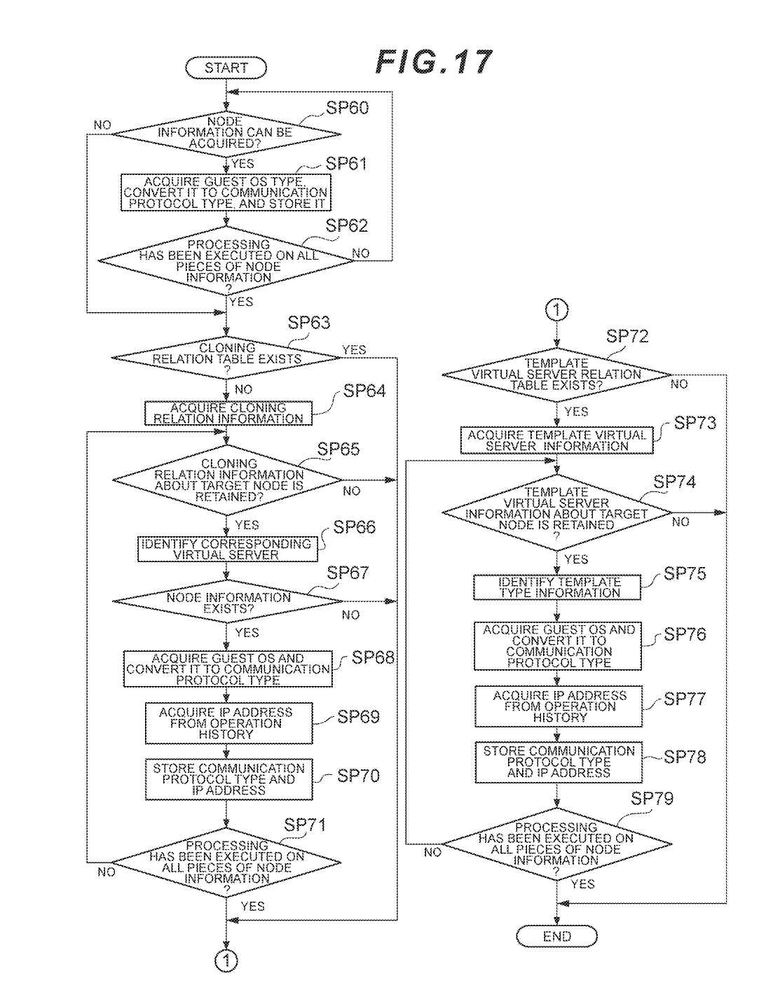

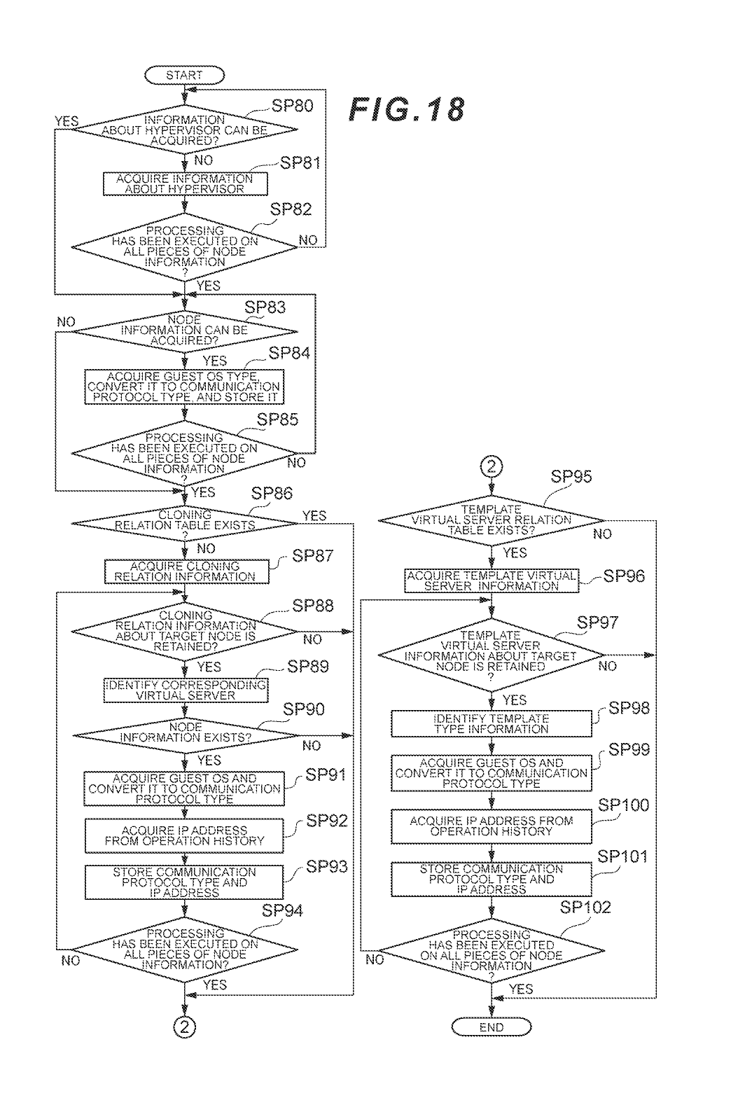

### BRIEF DESCRIPTION OF DRAWINGS

[FIG. 1] FIG. 1 is a block diagram illustrating an overall configuration of a computer system according to first and second embodiments.

[FIG. 2] FIG. 2 is a block diagram illustrating a schematic configuration of a management server.

[FIG. 3] FIG. 3 is a block diagram illustrating an example of the configuration of the computer system according to first and second embodiments.

[FIG. 4] FIG. 4 is a conceptual diagram showing the structure of a supported protocol table.

[FIG. 5] FIG. 5 is a conceptual diagram showing the structure of an authentication information table.

[FIG. 6] FIG. 6 is a conceptual diagram showing the structure of a search candidate table.

[FIG. 7] FIG. 7 is a conceptual diagram showing the structure of a search result table according to first and third embodiments.

[FIG. 8] FIG. 8 is a flowchart illustrating a processing sequence for first search processing.

[FIG. 9] FIG. 9 is a flowchart illustrating a processing sequence for other node information acquisition processing.

[FIG. 10] FIG. 10 is a flowchart illustrating a processing sequence for first virtual node information acquisition processing.

[FIG. 11] FIG. 11 is a flowchart illustrating a processing sequence for second virtual node information acquisition processing.

[FIG. 12] FIG. 12 is a conceptual diagram illustrating the structure of a search result table according to a second embodiment.

[FIG. 13] FIG. 13 is a flowchart illustrating a processing sequence for second search processing.

[FIG. 14] FIG. 14 is a block diagram illustrating an overall configuration of a computer system according to the third embodiment.

[FIG. 15] FIG. 15 is a conceptual diagram illustrating the structure of a cloning relation table.

[FIG. 16] FIG. 16 is a conceptual diagram illustrating the structure of a template virtual server table.

[FIG. 17] FIG. 17 is a flowchart illustrating a processing sequence for third virtual node information acquisition processing.

[FIG. 18] FIG. 18 is a flowchart illustrating a processing sequence for fourth virtual node information acquisition processing.

### DESCRIPTION OF EMBODIMENTS

An embodiment of the present invention will be explained below in detail with reference to the drawings.

### (1) First Embodiment

(1-1) Configuration of Computer System according to This Embodiment

Referring to FIG. 1, reference numeral 1 represents a computer system according to this embodiment as a whole. This computer system 1 is configured by including a management server 2, a management terminal 3, a physical server for virtual server 4, a physical server 5, a storage apparatus 6, a virtualization environment management server 7, and a management physical server 8.

The management server 2, the management terminal 3, the physical server for virtual server 4, the physical server 5, the storage apparatus 6, the virtualization environment management server 7, and the management physical server 8 are connected respectively via an IP (Internet Protocol) network 9 such as the Internet so that they can communicate with each other and send and receive commands and various types of control information via the IP network 9.

Moreover, the management server 2, the physical server for virtual server 4, the physical server 5, and the management physical server 8 are connected respectively to the storage apparatus 6 via a SAN (Storage Area Network) 10 so that they can communicate with the storage apparatus 6 and input/output data to/from the storage apparatus via the SAN 10.

The management server 2 is a server system for managing the entire computer system 1, collects various pieces of information about the relevant nodes (hereinafter referred to as the node information), such as configuration information, performance information, and status information, from the nodes such as the physical server for virtual server 4, the physical server 5, the storage apparatus 6, the virtualization environment management server 7, and the management physical server 8, which are connected via the IP network 9, and manages these nodes based on the collected node information.

The management terminal 3 is a computer device used by an administrator to manage the entire computer system 1. The administrator uses the management terminal 3 and, for example, makes the management terminal 3 read the node information about a desired node from the node information about each node retained by the management server 2 and makes the management terminal 3 display the node information; and when allocating an IP address range to a new user, the administrator can register, for example, the IP address range and authentication information (a user name and a password), which is used to log into a node within the IP address range, in the management server 2.

The physical server for virtual server 4 is a server system for providing a client, which is connected to the IP network 9 and not shown in the drawing, with one or more virtual computers (hereinafter referred to as the virtual servers). Moreover, the physical server 5 is a physical server system which is not equipped with such a virtualization function. The virtual servers and the physical server 5 are equipped with software used by a user for business activities and data used by the software to execute specified processing according to the user's business is read from and/or written to the storage apparatus 6 via the SAN 10.

The storage apparatus 6 is configured by including one or more storage devices and a control part for controlling input/output of data to/from these storage devices. The storage apparatus 6 provides the virtual servers created in the physical server for virtual server 4 and the physical server 5 with storage areas for reading/writing data.

The virtualization environment management server 7 is a server system for managing a hypervisor mounted in the physical server for virtual server 4 and described later and the virtual servers created in the physical server for virtual server 4; collects various types of node information such as configuration information, performance information, and status information about the hypervisor and each virtual server; and operates the hypervisor and the virtual servers, when necessary, based on the collected node information.

The management physical server 8 is a server system for managing physical nodes within the computer system 1; collects node information such as configuration information, performance information, and status information about each physical server system (the virtualization environment management server 7, the physical server for virtual server 4 and the physical server 5) and each storage apparatus 6, which are connected to the IP network 9 and the SAN 10, and about each network device constituting a physical network for business use within the computer system 1, which is configured separately from the IP network 9 and the SAN 10; and manages these nodes based on the collected information.

FIG. 2 illustrates a schematic configuration of the management server 2. As shown in FIG. 2, the management server 2 is configured by including a CPU 20, a main storage device 21, an auxiliary storage device 22, a network adapter 23, and a storage adapter 24. Then, the CPU 20, the main storage device 21, the auxiliary storage device 22, the network adapter 23, and the storage adapter 24 are connected via a shared bus 25 so that they can communicate with each other.

The CPU 20 is a processor for controlling the operation of the entire management server 2. Moreover, the main storage device 21 is composed of, for example, a semiconductor memory such as a DRAM (Dynamic Random Access Memory), is used to store, for example, various control programs and various types of control information, and is also used as a work memory for the CPU 20. A search program 26 described later is also stored and retained in this main storage device 21. As the CPU 20 executes control programs stored in the main storage device 21, various types of processing are executed by the management server 2 as a whole.

The auxiliary storage device 22 is composed of, for example, a large-capacity storage device such as a hard disk device or an SSD (Solid State Drive). The various control programs stored in the main storage device 21 are initially stored in this auxiliary storage device 22 and are read from the auxiliary storage device 22 and stored in the main storage device 21 at the time of activation of the management server 2 and execution of its control programs. Furthermore, the auxiliary storage device 22 stores the above-mentioned various types of node information collected by the management server 2.

The network adapter 23 is an adapter for connecting the management server 2 to the IP network 9 and controls a protocol when the management server 2 communicates with another node via the IP network 9. Furthermore, the storage adapter 24 is an adapter for connecting the management server 2 to the SAN 10 and controls a protocol when the management server 2 sends/receives data to/from the storage apparatus 6 via the SAN 10.

Incidentally, the management terminal 3, the virtualization environment management server 7, the management physical server 8, the physical server for virtual server 4, the physical server 5, and the storage apparatus 6 have the same hardware configuration as that of the management server 2, so that an explanation about them has been omitted.

FIG. 3 illustrates a logical configuration of the management server 2, the management terminal 3, the physical server for virtual server 4, the physical server 5, the storage apparatus 6, the virtualization environment management server 7, and the management physical server 8 in this computer system 1 explained above with reference to FIG. 1.

As is apparent from FIG. 3, the management server 2 is equipped with the search program 26 for collecting the node information from each node existing in the computer system 1; and a table group 27 for managing information collected by this search program 26 is stored in the auxiliary storage device 22 for the management server 2. The details of the search program 26 and the table group 27 will be explained later.

The management terminal 3 is equipped with an input/output program 34 for receiving a request from the administrator and executing corresponding processing in accordance with the received request. The management terminal 3 acquires necessary information from the management server 2, displaying the acquired information in a visible manner, and configures necessary settings to the management server 2 based on this input/output program 34.

The physical server for virtual server 4 is equipped with a general OS (hereinafter referred to as the host OS) such as Windows (registered trademark), Linux (registered trademark), HP-UX (registered trademark), Solaris (registered trademark), VOS3 (registered trademark), or z/OS (registered trademark) and is also equipped with a hypervisor 37 operating on this host OS 38. The hypervisor 37 is virtualization software which virtualizes computer resources for the physical server for virtual server 4 and provides clients with one or more virtual servers 35; and, for example, VMware ESX (registered trademark), VMware vSphere Hypervisor (registered trademark), Hyper-V (registered trademark), Virtage (registered trademark), KVM (registered trademark), XenServer (registered trademark), or OracleVM (registered trademark) is applied. The same or different type of OS (hereinafter referred to as the guest OS) operates independently on each virtual server 35. For example, Windows (registered trademark), Linux (registered trademark), HP-UX (registered trademark), Solaris (registered trademark), VOS3 (registered trademark), or z/OS (registered trademark) is applied as the guest OS 36. Moreover, each virtual server 35 is equipped with various types of application software which operates on the guest OS 36.

The physical server 5 means a server system which is not equipped with the hypervisor 37. This physical server 5 is equipped with a general OS (host OS 38) similar to that of the physical server for virtual server 4 and is also equipped with various application programs which operate on this host OS 38.

The virtualization environment management server 7 is equipped with a virtualization environment management program 39 for managing a virtualization environment in the computer system 1. The virtualization environment management server 7 collects node information such as configuration information (including IP addresses and an OS types), performance information, and status information from the virtual servers 35 and the hypervisor 37 for the physical server for virtual server 4 based on this virtualization environment management program 39 and performs various operations on the virtual servers 35 and the hypervisor 37. For example, vCenter Server (registered trademark) manufactured by VMware or System Center Virtual Machine Manager (registered trademark) manufactured by Microsoft can be applied as the virtualization environment management program 39.

The management physical server 8 is equipped with a server management program 40, a storage management program 42, and a network management program 44. The server management program 40 is a program for collecting node information such as configuration information (including IP addresses and OS types), performance information, and status information from each physical server system (such as the virtualization environment management server 7, the physical server for virtual server 4, and the physical server 5) within the computer system 1.

The management physical server 8 manages the collected node information about each server system based on this server management program 40 by storing it in a specified first management table (hereinafter referred to as the server management table) 41.

Moreover, the storage management program 42 is a program for collecting node information such as configuration information, performance information, and status information from each storage apparatus 6 within the computer system 1. The management physical server 8 manages the collected node information about each storage apparatus 6 based on this storage management program 42 by storing it in a specified second management table (hereinafter referred to as the storage management table) 43.

Furthermore, the network management program 44 is a program for collecting node information such as configuration information, performance information, and status information from each network device constituting a physical network for business use within the computer system 1 configured separately from the IP network 9 and the SAN 10 as described earlier. The management physical server 8 manages the collected node information about each network device based on this network management program 44 by storing it in a specified third management table (hereinafter referred to as the network management table) 45.

(1-2) Node Management Function according to This Embodiment

### (1-2-1) Outline and Table Structure

Next, a node management function provided in the management server 2 will be explained. The management server 2 according to this embodiment is equipped with the node management function that collects node information about nodes such as the physical server for virtual server 4, the physical server 5, the storage apparatus 6, the virtualization environment management server 7, and the management physical server 8, which are management targets connected via the IP network 9, and further node information about other nodes from nodes having the node information about other nodes, and recognizes and manages the status of each node which is a management target based on the collected node information.

Specifically speaking, when collecting the node information about each node in the IP network, the management server 2 sequentially tries access to the nodes according to a predefined protocol by using registered authentication information with respect to IP addresses in order within a designated IP address range. Then, if the management server 2 successfully accesses, for example, the virtualization environment management program 39 provided in the virtualization environment management server 7 retaining the node information about other nodes, the server management program 40 provided in the management physical server 8, and the hypervisor 37 provided in the physical server for virtual server 4, it becomes possible to collectively acquire the IP addresses and OS information about the plurality of physical servers 5 or virtual servers 35 managed by the virtualization environment management program 39, the server management program 40, and the hypervisor 37. As a result, it is possible to reduce time required for the processing for collecting the node information about the nodes.

As a means for executing the node management processing based on such a node management function, the auxiliary storage device 22 for the management server 2 stores a supported protocol table 30 illustrated in FIG. 4, an authentication information table 31 illustrated in FIG. 5, a search candidate table 32 illustrated in FIG. 6, and a search result table 33 illustrated in FIG. 7 as the aforementioned table group 27 (see FIG. 2).

The supported protocol table 30 is a table used to manage the protocol type of communication protocols supported by the management server (hereinafter referred to as the communication protocol type) and is constituted from a protocol ID column 30A and the supported protocol type column 30B as shown in FIG. 4.

Then, the protocol ID column 30A stores an identifier assigned to the corresponding communication protocol type (hereinafter referred to as the communication protocol ID) and the supported protocol type column 30B stores a type name (protocol name) of the relevant communication protocol supported by the management server.

Accordingly, FIG. 4 shows that the management server 2 supports communication protocols such as VMware API (registered trademark), SNMP (Simple Network Management Protocol), SMIS CIM/WEBEM, SSH (Secure Shell), and WMI (Windows Management Instrumentation).

The authentication information table 31 is a table used to manage the authentication information registered in advance in the management server 2 by the administrator via the management terminal 3 and is constituted from an authentication information ID column 31A, a user ID column 31B, and a password column 31C as shown in FIG. 5.

Then, the user ID column 31B stores a user identifier (user ID) configured by a user who uses the relevant node and the password column 31C stores the corresponding password configured by the user for the relevant node. Moreover, the authentication information ID column 31A stores an identifier assigned to the authentication information composed of the corresponding user ID and password (hereinafter referred to as the authentication information ID).

Accordingly, FIG. 5 shows that the authentication information ID of authentication information whose user ID is “root” and whose password is “Password” is “C1” and the authentication information ID of authentication information whose user ID is “Administrator” and whose password is “abc123” is “C3.”

Meanwhile, the search candidate table 32 is a table used to manage a correspondence relationship between an IP address range registered by the user in advance and the authentication information (the user ID and the password) configured for a node to which an IP address within the IP address range is assigned; and is constituted from an IP address range ID column 32A, an IP address range column 32B, and an authentication information column 32C as shown in FIG. 6.

Then, the IP address range column 32B stores an IP address range configured by the user. Moreover, the IP address range ID column 32A stores an identifier specific to the relevant IP address range assigned to the corresponding IP address range and the authentication information column 32C stores an authentication information ID (see FIG. 5) of authentication information to be used when accessing (or logging into) nodes to which the IP addresses within the corresponding IP address range are assigned.

Accordingly, FIG. 6 shows that the authentication information used to access nodes within an IP address range “192.168.0.0/24” to which an identifier “R1” is assigned is “C1.” Incidentally, “192.168.0.0/24” indicates the IP address range from “192.168.0.0” to “192.168.0.255.”

Meanwhile, the search result table 33 is a table used to manage the authentication information of each node on the IP network 9, which is acquired by first search processing, and protocols to be used when accessing the relevant node; and is constituted from a node ID column 33A, an IP address column 33B, an authentication information column 33C, and a protocol column 33D as shown in FIG. 7.

Then, the node ID column 33A stores an identifier which is assigned to the corresponding node and is specific to that node (node ID); and the IP address column 33B stores an IP address of the node. Moreover, the authentication information column 33C stores an authentication information ID (FIG. 5) of authentication information to be used when accessing the relevant node. Furthermore, the protocol column 33D stores a communication protocol ID (see FIG. 4) of a communication protocol to be used when accessing the relevant node.

Accordingly, in the case of FIG. 7, for example, it is shown that an IP address of a node to which a node ID “M1” is assigned is “192.168.0.1”; a communication protocol ID of a communication protocol to be used when accessing that node is “P2” (its communication protocol name is “SNMP” according to FIG. 4) and an authentication information ID of authentication information to be used when accessing the relevant node is “C1” (its user ID is “root” and its password is “Password” according to FIG. 5).

(1-2-2) Various Processing regarding Node Management Processing according to This Embodiment

Next, specific processing content of various processing regarding node management processing according to this embodiment will be explained.

### (1-2-2-1) First Search Processing

FIG. 8 illustrates a processing sequence for first search processing executed by the search program 26 for the management server 2. The search program 26 collects node information from each node within an IP address range designated as a search range in accordance with the processing sequence illustrated in FIG. 8.

In practice, after receiving the IP address range information and the authentication information (a user ID and a password) within the search range from the user via the management terminal 3, the search program 26 starts this first search processing; and firstly temporarily store the received IP address range, which should be the search range, and the authentication information to be used when accessing nodes within that IP address range, in the auxiliary storage device 22 and selects one IP address within the IP address range (SP1).

Then, the search program 26 judges whether the node information about a node to which the then target IP address selected in step SP1 (hereinafter referred to as the target IP address) is assigned has been collected or not (SP2). Incidentally, this judgment is performed by judging whether or not a record (row) which stores the target IP address exists in the IP address column of the search result table 33 (FIG. 7). Then, if the search program 26 obtains an affirmative result for this judgment, it proceeds to step SP7.

On the other hand, if the search program 26 obtains a negative judgment result in step SP2, it refers to the target IP address, the authentication information, which is associated with the target IP address and registered in the authentication information table 31, and the supported protocol table 30 stored in the auxiliary storage device 22, and tries access sequentially to the node, to which the target IP address is assigned, according to each of the protocols supported by the management server 2 in the order registered in the supported protocol table 30 (SP3).

Then, the search program 26 judges whether or not the node has been successfully accessed according to any of the protocols in step SP3 (SP4).

To obtain the negative result for this judgment means that no node to which the target IP address is assigned exists or, even if it does exist, it is impossible to communicate with that node for whatever reason (for example, that node is not powered on or it is impossible to communicate with that node according to the communication protocol(s) supported by the management server). Consequently, when this happens, the search program 26 proceeds to step SP7.

On the other hand, to obtain the affirmative judgment result in step SP4 means that the node to which the target IP address is assigned has been successfully accessed. Consequently, when this happens, the search program 26 stores the target IP address, the communication protocol type indicating the protocol type of the communication protocol which then enabled the access, and the authentication information used for the access in the search result table 33 (SP5).

Then, if the node successfully accessed in step SP4 retains node information about other nodes, the search program 26 executes other node information acquisition processing for acquiring the node information about all other nodes, which is retained by the relevant node, from that node (SP6).

Subsequently, the search program 26 judges whether the execution of the processing from step SP1 to step SP6 on all IP addresses within the then target IP address range has been completed or not (SP7).

Then, if the search program 26 obtains a negative result for this judgment, it returns to step SP1 and repeats the same processing (from step SP1 to step SP7 and then back to step SP1) while switching the IP address selected in step SP1 sequentially to another IP address.

Then, if the search program 26 obtains an affirmative result in step SP7 by completing the execution of the processing from step SP1 to step SP6 on all the IP addresses within the then target IP address range, it terminates this first search processing.

### (1-2-2-2) Other Node Information Acquisition Processing

FIG. 9 illustrates specific processing content of the other node information acquisition processing executed in step SP6 of the above-described first search processing (FIG. 8).

When the search program 26 proceeds to step SP6 of the search processing, it starts the other node information acquisition processing illustrated in FIG. 9 and firstly judges whether the node type of the node to which the target IP address is assigned is an “OS” or not (SP10).

Incidentally, for example, since a specified communication protocol may sometimes be used for a specified node type, a judgment method for judging the node type of the node, to which the target IP address is assigned, based on the communication protocol type obtained in step SP5 of the first search processing described earlier with reference to FIG. 8 can be applied as a judgment means for the above-described judgment. Moreover, for example, the search program 26 may send a command to the node, to which the target IP address is assigned, to check the node type of that node and may judge the node type of the relevant node based on its response. The same applies to a judgment from step SP11 to step SP14 described below.

Now, to obtain the affirmative judgment result in step SP10 means that the then accessed node is the OS mounted on a physical server 5 or a physical server for virtual server 4. Consequently, when this happens, the search program 26 judges whether the hypervisor 37 operating on that OS exists or not, for example, by sending an inquiry to the OS (SP15).

To obtain the negative judgment result in step SP15 means that the then accessed node is a physical server 5. Consequently, when this happens, the search program 26 terminates this other node information acquisition processing.

On the other hand, to obtain the affirmative judgment result in step SP15 means that the then accessed node is a physical server for virtual server 4. Consequently, when this happens, the search program 26 acquires the IP address of that hypervisor 37 and the communication protocol type to access the hypervisor 37 from the OS (SP16).

Subsequently, the search program 26 accesses the hypervisor 37 based on the IP address of the hypervisor 37 acquired in step SP16, acquires an IP address used to access the relevant virtual server 35 and an OS type of the guest OS 36 of that virtual server 35 with respect to each virtual server 35 managed by the relevant hypervisor 37 (that is, each virtual server 35 generated by the hypervisor 37) (SP17), and then terminates the other node information acquisition processing.

On the other hand, if the search program 26 obtains a negative judgment result in step SP10, it judges whether the node type of the node to which the target IP address is assigned is a “hypervisor” or not (SP11). Then, if the search program 26 obtains an affirmative result for this judgment, it judges whether an IP address of the virtualization environment management program 39 for managing that hypervisor 37 and a communication protocol type for accessing that virtualization environment management program 39 are retained by that hypervisor 37 or not (SP18).

Then, if the search program 26 obtains a negative result for this judgment, it proceeds to step SP17, acquires the OS type of the guest OS 36 mounted on each virtual server 35 managed by the relevant hypervisor 37 (that is, each virtual server 35 generated by the hypervisor 37) and the IP address of the virtual server 35 from the hypervisor 37 recognized in step SP11 (SP17), and then terminates the other node information acquisition processing.

On the other hand, if the search program 26 obtains an affirmative judgment result in step SP18, it acquires the IP address of the virtualization environment management program 39 and the communication protocol type for accessing the relevant virtualization environment management program 39 from the hypervisor 37 (SP19) and access the node of the acquired IP address by using the communication protocol type acquired in step SP19 (SP20).

Then, the search program 26 judges whether the access has been successfully made or not (SP21); and if it obtains a negative result, it proceeds to step SP17, executes the first virtual node information acquisition processing for acquiring the OS type of the guest OS 36 for each virtual server 35 managed by the relevant hypervisor 37 (that is, each virtual server 35 generated by the hypervisor 37) and the IP address of the virtual server 35 from the hypervisor 37 recognized in step SP11 (SP17), and then terminates the other node information acquisition processing.

On the other hand, if the search program 26 obtains an affirmative judgment result in step SP21, it executes second virtual node information acquisition processing for acquiring the node information about each hypervisor 37 and each virtual server 35 managed by the virtualization environment management program 39 from the virtualization environment management program 39 (SP22) and then terminates the other node information acquisition processing.

On the other hand, if the search program 26 obtains a negative judgment result in step SP11, it judges whether the node type of the node to which the target IP address is assigned is a “virtualization environment management program” or not (SP12). Then, if the search program 26 obtains an affirmative result for this judgment, it executes the second virtual node information acquisition processing for acquiring the node information about each hypervisor 37 and each virtual node 35 managed by the virtualization environment management program 39 from the virtualization environment management program 39 (SP22) and then terminates the other node information acquisition processing.

Furthermore, if the search program 26 obtains a negative judgment result in step SP12, it judges whether the node type of the node to which the target IP address is assigned is a “server management program” or not (SP13). Then, if the search program 26 obtains an affirmative result for this judgment, it acquires the node information about each physical server 5 (including the physical server for virtual server 4) managed by the server management program 40 from the server management program 40, stores the acquired node information about each physical server 5 (including the physical server for virtual server 4) in the search result table 33 (SP23), and then terminates the other node information acquisition processing.

On the other hand, if the search program 26 obtains a negative judgment result in step SP13, it judges whether the node type of the node to which the target IP address is assigned is a “storage management program” or not (SP14). Then, if the search program 26 obtains an affirmative result for this judgment, it acquires the node information about each storage apparatus 6 managed by the storage management program 42 from the storage management program 42, stores the acquired node information about each storage apparatus 6 in the search result table 33 (SP24), and then terminates the other node information acquisition processing.

Furthermore, if the search program 26 obtains a negative judgment result in step SP14, it determines that the node type of the node to which the target IP address is assigned is a “network management program”; and acquires the node information about each network device managed by the network management program 44, stores the acquired node information about each network device in the search result table 33 (SP25), and then terminates the other node information acquisition processing.

### (1-2-2-3) First Virtual Node Information Acquisition Processing

FIG. 10 illustrates specific processing content of the first virtual node information acquisition processing executed by the search program 26 in step SP17 of the above-mentioned other node information acquisition processing (FIG. 9). The search program 26 acquires the node information about the virtual servers 35 managed by the hypervisor 37, which is a target node, from that hypervisor 37 in accordance with the processing sequence illustrated in FIG. 10.

Specifically speaking, when the search program 26 proceeds to step SP17 of the other node information acquisition processing, it starts the first virtual node information acquisition processing illustrated in FIG. 10 and firstly accesses the then target hypervisor 37 acquired in step SP5 of the first search processing described earlier with reference to FIG. 8 by using the IP address and the communication protocol type of the hypervisor 37. Then, the search program 26 refers to the search result table 33 and judges whether or not the hypervisor 37 retains the node information about a node (a virtual server 35) which is not registered in the search result table 33 (SP30). Then, if the search program 26 obtains a negative result for this judgment, it terminates this first virtual node information acquisition processing.

On the other hand, if the search program 26 obtains an affirmative judgment result in step SP30, it selects one piece of node information about the node (the virtual server 35), which is not registered in the search result table 33, from the node information retained by the hypervisor 37 and acquires the selected node information from the hypervisor 37. Then, the search program 26 acquires the communication protocol type to be used when communicating with the relevant node, based on the OS type of the guest OS 36 mounted on that node included in the acquired node information and stores this communication protocol type and the IP address included in the node information in the search result table 33 (SP31).

Subsequently, the search program 26 judges whether the execution of the processing in step SP30 and step SP31 on all other nodes (virtual servers 35) retained by the hypervisor 37 has been completed or not (SP32).

If the search program 26 obtains a negative result in step SP32, it returns to step SP30 and then repeats the same processing (from step SP30 to step SP32 and then back to step SP30).

Then, if the search program 26 obtains an affirmative result in step SP32 by completing the execution of the processing from step SP30 to step SP32 on all the pieces of node information retained by the hypervisor 37, it terminates this first virtual node information acquisition processing.

### (1-2-2-4) Second Virtual Node Information Acquisition Processing

Meanwhile, FIG. 11 illustrates specific processing content of the second virtual node information acquisition processing executed by the search program 26 in step SP22 of the aforementioned other node information acquisition processing (FIG. 9). The search program 26 acquires the node information about the hypervisor 37 and the virtual servers 35 managed by the virtualization environment management program 39, which is a target node, from that virtualization environment management program 39 in accordance with the processing sequence illustrated in FIG. 11.

When the search program 26 proceeds to step SP22 of the other node information acquisition processing, it starts the other second virtual node information acquisition processing illustrated in FIG. 11 and firstly accesses the virtualization environment management program 39 which was acquired in step SP5 of the first search processing described earlier with reference to FIG. 8 and is a target at that time, by using the IP address and the communication protocol type of the virtualization environment management program 39. Then, the search program 26 refers to the search result table 33 and judges whether or not the virtualization environment management program 39 retains the node information about a hypervisor 37 which is not registered in that search result table 33 (SP40). Then, if the search program 26 obtains a negative result for this judgment, it terminates this first virtual node information acquisition processing.

On the other hand, if the search program 26 obtains an affirmative judgment result in step SP40, it selects one piece of the node information about the hypervisor 37, which is not registered in the search result table 33, from the node information retained by the virtualization environment management program 39 and acquires the selected node information from the virtualization environment management program 39. Then, the search program 26 acquires the communication protocol type to be used when communicating with that hypervisor 37, based on the acquired node information and stores this communication protocol type and the IP address included in the node information in the search result table 33 (SP41).

Then, the search program 26 judges whether the execution of the processing in step SP40 and step SP41 on all hypervisors 37 retained by the virtualization environment management program 39 has been completed or not (SP42).

If the search program 26 obtains a negative result in step SP42, it returns to step SP40 and then repeats the same processing (from step SP40 to step SP42 and then back to step SP40).

Then, if the search program 26 obtains an affirmative result in step SP42 by completing the execution of the processing from step SP40 to step SP42 on the node information about all the hypervisors 37 retained by the virtualization environment management program 39, it executes processing from step SP43 to step SP45 in the same manner as in step SP30 to step SP32 of the first virtual node information acquisition processing described earlier with reference to FIG. 10. Accordingly, the search program 26 registers the node information about the virtual server(s) 35 which is not registered in the search result table 33 among the node information about the virtual servers 35 retained by the virtualization environment management program 39, sequentially in the search result table 33. Then, the search program 26 terminates this second virtual node information acquisition processing.

### (1-3)Advantageous Effects of This Embodiment

According to this embodiment as described above, for example, it is possible to acquire the node information about the virtual servers 35 managed by the virtualization environment management program 39 and the hypervisor 37 and reduce time required for the series of processing as compared to the conventional case in which access is tried sequentially to one IP address to another according to a plurality of protocols. Consequently, it is possible to realize a computer system capable of reducing node discovery time in the computer system with a large number of nodes and a large number of supported protocols.

### (2) Second Embodiment

(2-1) Configuration of Computer System according to This Embodiment

Reference numeral 50 in FIG. 1 and FIG. 3 represents a computer system according to a second embodiment as a whole. The computer system 50 is configured in the same manner as the computer system 1 according to the first embodiment, except that, in addition to the fact that this computer system 50 executes processing for acquiring node information about another node(s) from a node (such as the virtualization environment management program 39, the hypervisor 37, or the server management program) which retains the node information of such other node (hereinafter referred to as the pseudo-search processing), the computer system 50 executes processing for verifying whether such other node can be accessed or not, based on the node information about the other nodes, which is acquired by the pseudo-search processing (hereinafter referred to as the actual search processing).

In practice, when a search program 52 for a management server 51 collectively acquires the node information (such as IP address and OS type information) about the other node managed by the virtualization environment management program 39, etc. from the virtualization environment management program 39, etc. according to the first embodiment, it stores the node information in the search result table 33 without verifying whether such other node can be accessed or not, based on the acquired node information.

However, for example, the IP address or the communication protocol type of a virtual server 35, etc. is changed by an individual user who uses the virtual server 35, etc. and the search program 26 receives the node information, in which the change has not been reflected, from the virtualization environment management program 39 before having the change reflected in the node information about the relevant virtual server 35, etc. managed by the virtualization environment management program 39, etc., and if the management server 51 tries to access the relevant virtual server 35, etc. based on the acquired IP address or the communication protocol type in which the change has not been reflected, this will result in a situation where the management server 51 cannot access the relevant virtual server 35.

So, when the search program 52 acquires the node information about another node, which is managed by a certain node, from that node in this embodiment, it executes the actual search processing for verifying whether the relevant other node can be actually accessed or not, based on the acquired node information.

Moreover, if the search program 52 has not made access to node information (the authentication information and the protocol) about a node with the target IP address by using its predefined protocol, it executes processing for trying access to the node according to the predefined protocol. Then, if the access of this processing fails, the search program 52 tries access by using another protocol stored in the supported protocol table 30 of the management server 51. Then, if the node is accessed successfully, the search program 52 overwrites the relevant part of the node information about the node with the target IP address in the search result table 54 with the protocol by which the access was made successfully.

As a means for realizing the node management processing according to this embodiment described above, the search result table 54 illustrated in FIG. 12, instead of the search result table 33 (FIG. 7) described earlier with reference to FIG. 7, is stored in the auxiliary storage device 22 for the management server 51.

This search result table 54 is, like the search result table 33 according to the first embodiment, a table used to manage the authentication information about each node on the IP network 9, which is acquired by search processing described later, and protocols to be used when accessing the node; and is constituted from a node ID column 54A, an IP address column 54B, an authentication information column 54C, a protocol column 54D, and a search flag column 54E as shown in FIG. 12.

Then, the node ID column 54A, the IP address column 54B, the authentication information column 54C, and the protocol column 54D store the same information as the information stored in their corresponding columns (the node ID column 33A, the IP address column 33B, the authentication information column 33C, or the protocol column 33D) respectively in the search result table 33 according to the first embodiment.

Moreover, the search flag column 54E stores a flag indicating whether either the pseudo-search processing or the actual search processing on the corresponding node for the relevant row in the search result table 54 has been completed or not (hereinafter referred to as the search flag). Incidentally, the search flag is set: as “T” when the pseudo-search processing on the corresponding node has been completed; and as “F” when the actual search processing on that node has been completed.

So, FIG. 12 show that, for example, the node information (the IP address, the authentication information, and the communication protocol type) about a node to which a node ID “M1” is assigned is acquired from any of the nodes; and only the pseudo-search processing has been completed on the node “M1” and the actual search processing has not been executed on that node.

(2-2) Search Processing according to This Embodiment

Next, a processing sequence for search processing according to this embodiment will be explained.

### (2-2-1) Second Search Processing

FIG. 13 illustrates a processing sequence for second search processing executed by the search program 52 for the management server 51. The search program 52 collects the node information from each node within an IP address range designated as a search range in accordance with the processing sequence illustrated in FIG. 12.

In practice, after receiving the IP address range information and the authentication information (a user ID and a password) within the search range, the search program 52 starts this second search processing; and firstly temporarily stores the IP address range, which should be the search range given from the management terminal 3, and the authentication information, which should be used when accessing nodes within that IP address range, in the auxiliary storage device 22 and selects one IP address within the IP address range (SP50).

Subsequently, the search program 52 judges whether or not a node to which the target IP address selected in step SP50 is assigned is a node whose node information has been acquired by the pseudo-search processing (SP51). This judgment is performed by searching the search result table 54 and judging whether or not any record in any of the IP address column 54B in which the target IP address is stored exists and whether a value of a search flag stored in the search flag column 54E of that record is set as “T.”

Then, if the search program 52 obtains a negative result for this judgment, it executes processing from step SP54 to step SP57 in the same manner as from step SP3 to step SP6 of the first search processing explained with reference to FIG. 8. As a result, the search program 52 acquires the node information about the node, to which the target IP address is assigned, from that node and stores the acquired node information in the search result table 54. Moreover, if that node retains node information about another node, the search program 52 acquires the node information about that other node and stores the acquired node information in the search result table 54.

When under this circumstance the search program 52 registers the then acquired node information in the search result table 54 in step SP23, step SP24, or step SP25 of the other node information acquisition processing which is executed in step SP57 and described with reference to FIG. 9, in step SP 31 of the first virtual node information acquisition processing executed in the other node information acquisition processing and described with reference to FIG. 10, or in steps SP 41 and SP 44 of the second virtual node information acquisition processing described with reference to FIG. 11, it configures the search flag, which is stored in the search flag column 54E of the record (row) storing the relevant node information, as “T.”

Subsequently, the search program 52 configures the sear flag, which is stored in the search flag column 54E of the record for the node corresponding to the target IP address in the search result table 54, as “F” (SP58) and then judges whether the searching flags, which are stored in the corresponding search flag column 54E of the search result table 54 for all the nodes registered in the search result table 54, are set as “F” or not (SP59).

Then, if the search program 52 obtains a negative result for this judgment, it returns to step SP50 and then repeats the same processing by switching the IP address to be selected in step SP50 sequentially from one IP address to another.

On the other hand, if the search program 52 obtains an affirmative judgment result in step SP51, it acquires the communication protocol type to be used when accessing the node, to which the target IP address is assigned, from the search result table 54 and tries access to that node according to that communication protocol type (SP52), and judges whether such access has been made successfully or not (SP53).

If the search program 52 obtains a negative result for this judgment, it deletes the record of that node form the search result table, then proceeds to step SP54, and executes processing in step SP54 and subsequent steps in the same manner as described above.

On the other hand, if the search program 52 obtains an affirmative judgment result in step SP53, it configures the search flag, which is stored in the search flag column 54E of the record for the node corresponding to the target IP address in the search result table 54, as “F” (SP58), and then judges whether the searching flags, which are stored in the corresponding search flag column 54E of the search result table 54 for all the nodes registered in the search result table 54, are set as “F” or not (SP59).

If the search program 52 obtains a negative result for this judgment, it returns to step SP50 and then repeats the same processing by switching the IP address to be selected in step SP50 sequentially from one IP address to another.

Then, if the search program 52 obtains an affirmative result in step SP59 by completing the execution of the processing from step SP50 to step SP58 with respect to all the IP addresses within the then target IP address range, it terminates this second search processing.

### (2-3) Advantageous Effects of This Embodiment

According to this embodiment as described above, it is possible to check whether the node(s) based on the node information about the virtual server(s) 35 managed by the virtualization environment management program 39 and the hypervisor 37 can be actually accessed or not. As a result, it is possible to realize the computer system capable of obtaining the advantageous effect of acquiring highly reliable node information in addition to the advantageous effects which can be obtained by the computer system 1 according to the first embodiment.

### (3) Third Embodiment

(3-1) Configuration of Computer System according to This Embodiment

Referring to FIG. 14, reference numeral 60 represents a computer system according to a third embodiment as a whole. This computer system 60 is configured in the same manner as the computer system 1 according to the first embodiment, except that it acquires, in addition to the node information (the IP addresses, the authentication information, and the communication protocol types) about nodes managed by the virtualization environment management program 67 and the hypervisor 63, the node information (the IP addresses, the authentication information, and the communication protocol types) about the nodes based on cloning relation tables 64, 68 which store information about a correspondence relationship between a replication source virtual server 35 and a replication destination virtual server 35 at the time of replication of a virtual server 35 by means of cloning by the virtualization environment management program 67, and template virtual server relation tables 65, 69 which store a correspondence relationship between a template and a virtual server 35 at the time of creation of the virtual server 35 by the virtualization environment management program 67 and the hypervisor 63 by using the template.

In practice, the search program 61 for the management server 2 collectively acquires the node information about other nodes managed by the virtualization environment management program 67, etc. from the virtualization environment management program 67, etc. according to the first embodiment. The node information about the node(s) is collected by the individual virtual servers 35 and the hypervisor 63 by activation of the agent program by the virtualization environment management program 67 and the hypervisor 63 at certain timing.

However, for example, there are cases, depending on the virtual servers 35, where a guest OS 36 which is not supported by the virtualization environment management server 66 and the hypervisor 63 is operated, where the agent program is not operated on the guest OS 36, or where the operation of the agent program is suspended by the user; and in such cases, the virtualization environment management program 67 and the hypervisor 63 cannot acquire the node information about the node from the relevant virtual server 35.

So, in a case of this embodiment, the search program 61 identifies the other virtual server 35 which forms a cloning relationship with a target virtual server 35 based on cloning relation information about virtual servers 35 stored in the cloning relation tables 64, 68. Then, if the search program 61 has executed the search processing on the other virtual server 35 and has the node information about the node with respect to the relevant virtual server 35, it acquires the OS type of the guest OS 36 from the node information about the node for the other virtual server 35 and stores this OS type as the OS type of the search target virtual server 35. On the other hand, if the search program 61 acquires the node information about the node based on the template virtual server relation tables 65, 69, it acquires the OS type of the guest OS 36 based on template type information about the target virtual server 35 and stores this OS type as the OS type of the search target virtual server 35.

As a means for realizing the node management processing according to this embodiment as described above, the cloning relation table 64 and the template—virtual server relation table 65 which are shown in FIG. 14 are stored in the physical server for virtual server 62.

The cloning relation table 64 is a table used to manage replication destinations of virtual servers 35 created by means of cloning; and is constituted from a cloning pair ID column 64A, a cloning source virtual server ID column 64B, and a cloning destination virtual server ID column 64C as shown in FIG. 15.

Then, when the relevant virtual server 35 forms a cloning relationship with the other virtual server 35, the cloning pair ID column 64A stores an identifier assigned to cloning relation information of the relevant cloning pair (hereinafter referred to as the cloning pair ID). Moreover, the cloning source virtual server ID column 64B stores a unique identifier which is assigned to a replication source virtual server 35 replicated by cloning and is specific to that virtual server 35 (hereinafter referred to as the virtual server ID). Furthermore, the cloning destination virtual server ID column 64C stores the virtual server ID of a replication destination virtual server 35 replicated by means of cloning of the above-mentioned virtual server 35.

Accordingly, FIG. 15 shows that, for example, a virtual server 35 to which an identifier “VM01” is assigned is a replication source virtual server 35 for a virtual server 35, to which an identifier “VM04” is assigned, and forms a cloning pair with a cloning pair ID “CR1” with the virtual server 35 “VM04.”

On the other hand, the template—virtual server relation table 65 is a table used to manage a correspondence relationship between a template for the configuration information about a pre-registered virtual server 35 and the virtual server 35 created according to that template; and is constituted from a template virtual server ID column 65A, a template type ID column 65B, and a generated virtual server ID column 65C as shown in FIG. 16.

Then, the template type ID column 65B stores an identifier which is assigned to information indicating the type of the relevant template and is specific to that template type information (hereinafter referred to as the template type ID); and the generated virtual server ID column 65C stores a virtual server ID of a virtual server 35 generated according to that template. Moreover, the template virtual server ID column 65A stores an identifier assigned to template virtual server information composed of the corresponding template type information and the generated virtual server ID.

Accordingly, in a case of FIG. 16, for example, template virtual server information to which the identifier “TR1” is assigned indicates that a virtual server 35 to which the identifier “VM01” is assigned is generated based on a template with the identifier “Template01” including the configuration information about the virtual server 35.

Moreover, the virtualization environment management server 66 stores the cloning relation table 68 shown in FIG. 15 and the template—virtual server relation table 69 shown in FIG. 16. Since the cloning relation table 68 and the template—virtual server relation table 69 are similar to the cloning relation table 64 and the template—virtual server relation table 65 of the physical server for virtual server 62 respectively, a detailed explanation about them has been omitted.

(3-2) Search Processing according to This Embodiment

Next, a processing sequence for search processing according to this embodiment will be explained. Processing for acquiring node information about a virtual node according to this embodiment, which is executed during the other node information acquisition processing according to the first embodiment, will be explained below.

### (3-2-1) Third Virtual Node Information Acquisition Processing

FIG. 17 illustrates specific processing content of third virtual node information acquisition processing according to this embodiment, which is executed by the search program 61 in step SP17 of the aforementioned other node information acquisition processing (FIG. 9) according to the first embodiment. The search program 61 acquires, from that hypervisor 63 which is a target node, the node information (the IP address, the authentication information, and the protocol) about a node based on the cloning relation table 64 and the template—virtual server relation table 65, which are stored when the hypervisor 63 creates a virtual server 35 by means of cloning by using a template, in addition to the node information about the virtual server(s) 35 managed by the hypervisor 63, in accordance with the processing sequence illustrated in FIG. 17.

Specifically speaking, when the search program 61 proceeds to step SP17 of the other node information acquisition processing according to the first embodiment, it starts the third virtual node information acquisition processing illustrated in FIG. 17 and firstly accesses a relevant hypervisor 63 acquired in step SP16 of the other node information acquisition processing described earlier with reference to FIG. 9 based on the IP address of that hypervisor 63 and the communication protocol type used when communicating with that hypervisor 63. Then, the search program 61 refers to the search result table 33 and judges whether or not the hypervisor 63 retains the node information about a node (virtual server 35) which is not registered in the search result table 33 (SP60). Then, if the search program 61 obtains a negative result for this judgment, it proceeds to step SP53.

On the other hand, if the search program 61 obtains an affirmative judgment result in step SP50, it select one piece of the node information about the node (virtual server 35), which is not registered in the search result table 33, from the node information about nodes retained by the hypervisor 63 and acquires the selected node information from the hypervisor 63. Then, the search program 61 acquires the communication protocol type to be used when communicating with that node, based on the OS type of the guest OS 36 mounted on that node included in the acquired node information about the node and stores this communication protocol type and the IP address included in the node information in the search result table 33 (SP61).

Next, the search program 61 judges whether the execution of the processing from step SP60 to step SP62 on the node information about all other nodes (virtual servers 35) retained by the hypervisor 63 has been completed or not (SP62). Then, if the search program 61 obtains an affirmative result for this judgment, it proceeds to step SP63.

On the other hand, if the search program 61 obtains a negative result in step SP62, it returns to step SP60. Then, the search program 61 repeats the same processing (from step SP60 to step SP62 and then back to step SP60).

Then, when the search program 61 completes the processing from step SP60 to step SP62 on all the pieces of node information retained by the hypervisor 63, it proceeds to step SP63.

Subsequently, the search program 61 judges whether the hypervisor 63 retains the cloning relation table 64 or not (SP63). Then, if the search program 61 obtains a negative result for this judgment, it proceeds to step SP65.

On the other hand, if the search program 61 obtains an affirmative result in step SP53, it acquires cloning relation information about the virtual servers 35 from the cloning relation table 64 retained by the hypervisor 63 and temporarily stores it in the auxiliary storage device 22 (SP64).

Then, the search program 61 judges whether or not the cloning relation information acquired in step SP64 stores the cloning relation information corresponding to a node (virtual server 35) which is not registered in the search result table 33 (SP65). Then, if the search program 61 obtains a negative result for this judgment, it terminates this third virtual node information acquisition processing.

On the other hand, if the search program 61 obtains an affirmative result in step SP55, it identifies the other virtual server 35 which forms a cloning relationship with the target virtual server 35 based on that cloning relation information (SP66).

The search program 61 judges whether or not the search result table 33 retains the node information about a node for the other virtual server 35 acquired in step SP66 (SP67). Then, if the search program 61 obtains a negative result for this judgment, it terminates this third virtual node information acquisition processing.

On the other hand, if the search program 61 obtains an affirmative result in step SP67, it acquires the communication protocol type to be used when communicating with the relevant node, based on the OS type of the guest OS 36 mounted on that node included in the node information about the other virtual server 35 stored in the search result table 33 (SP68).

Then, the search program 61 identifies the IP address of the target virtual server 35 recorded at the time of cloning by checking an operation history (SP69).

The search program 61 stores the node information (the IP address, the authentication information, and the communication protocol type) about the node, which was acquired in step SP68 and step SP69, in the search result table 33 (SP70).

Subsequently, the search program 61 judges whether the execution of the processing from step SP65 to step SP70 on the node information about all other nodes (virtual servers 35) retained by the search program 61 has been completed or not (SP71). Then, if the search program 61 obtains an affirmative result for this judgment, it proceeds to step SP72.

On the other hand, if the search program 61 obtains a negative result in step SP61, it returns to step SP63. Then, the search program 61 repeats the same processing (from step SP65 to step SP71 and then back to step SP65).

Then, after completing the execution of the processing from step SP65 to step SP71 on all the pieces of node information retained by the hypervisor 63, the search program 61 proceeds to step SP72.

Subsequently, the search program 61 judges whether the hypervisor 63 retains the template—virtual server relation table 65 or not (SP72). Then, if the search program 61 obtains a negative result for this judgment, it terminates this third virtual node information acquisition processing.

On the other hand, if the search program 61 obtains an affirmative result in step SP63, it acquires template virtual server information about the virtual servers 35 from the template—virtual server relation table 65 retained by the hypervisor 63 and temporarily stores it in the auxiliary storage device 22 (SP73).

Then, the search program 61 judges whether or not the template virtual server information acquired in step SP73 stores the template virtual server information corresponding to a node (virtual server 35) which is not registered in the search result table 33 (SP74). Then, if the search program 61 obtains a negative result for this judgment, it terminates this third virtual node information acquisition processing.

On the other hand, if the search program 61 obtains an affirmative result in step SP74, it identifies the template type information about the target virtual server 35 from the template virtual server information (SP75).

The search program 26 fetches information about the guest OS 36 from the template type information acquired in step SP75 and acquires the communication protocol type to be used when communicating with the relevant node, based on the OS type of this guest OS 36 (SP76).

Then, the search program 61 identifies the IP address of the target virtual server 35 recorded at the time of replication based on the template type information by checking the operation history (SP77).

The search program 61 stores the node information (the communication protocol type and the IP address) about the node, which was acquired in step SP65 and step SP66, in the search result table 33 (SP78).

Subsequently, the search program 61 judges whether the execution of the processing from step SP74 to step SP78 on the node information about all other nodes (virtual servers 35) retained by the hypervisor 63 has been completed or not (SP79). Then, if the search program 61 obtains an affirmative result for this judgment, it terminates this third virtual node information acquisition processing.

On the other hand, if the search program 61 obtains a negative result in step SP79, it returns to step SP50. Then, the search program 61 repeats the same processing (from step SP74 to step SP79 and then back to step SP74).

Then, if the search program 61 completes the execution of the processing from step SP74 to step SP79 on all the pieces of node information retained by the hypervisor 63, it terminates this third virtual node information acquisition processing.

### (3-2-2) Fourth Virtual Node Information Acquisition Processing

FIG. 18 illustrates specific processing content of fourth virtual node information acquisition processing according to this embodiment executed by the search program 61 in step SP 18 of the aforementioned other node information acquisition processing (FIG. 9) according to the first embodiment. The search program 61 acquires, from the virtualization environment management program 67 which is a target node, the node information (the IP address, the authentication information, and the communication protocol type) about a node based on the cloning relation table 68 and the template—virtual server relation table 69 stored at the time of creation of a virtual server 35 by the virtualization environment management program 67 by means of cloning and by using a template, in addition to the node information about the hypervisor 63 and the virtual servers 35 managed by the virtualization environment management program 67, in accordance with the processing sequence illustrated in FIG. 18.

Specifically speaking, when the search program 61 proceeds to step SP22 of the other node information acquisition processing according to the first embodiment, it starts fourth virtual node information acquisition processing illustrated in FIG. 18; and firstly accesses the virtualization environment management program 67 based on the IP address and the communication protocol type of the virtualization environment management program 67 which were acquired as a result of the judgment in step SP12 and step SP21 of the other node information acquisition processing described earlier with reference to FIG. 9, compares it with the node information about the hypervisor 63 stored in the search result table 33 of the auxiliary storage device 22, and judges whether or not the node information about a hypervisor 63, which has not yet been acquired by the management server 2, can be acquired from the node information about the nodes managed by the virtualization environment management program 67 (SP80). If the search program 61 obtains a negative result for this judgment, it proceeds to step SP83.

On the other hand, if the search program 61 obtains an affirmative result in step SP80, it acquires the node information about the hypervisor 63 from the virtualization environment management program 67. Then, the search program 61 acquires the communication protocol type from the acquired OS and stores this communication protocol type and the IP address in the search result table 33 of the auxiliary storage device 22 (SP81).

Subsequently, the search program 61 judges whether the execution of the processing from step SP80 to step SP82 on the node information about all other nodes (hypervisors 63) retained by the virtualization environment management program 67 has been completed or not (SP82). Then, if the search program 61 obtains an affirmative result for this judgment, it acquires the node information about all the virtual servers 35 and the hypervisors 63 managed by the virtualization environment management program 67 by executing the processing from step SP83 to step SP102 in the same manner as from step SP60 to step SP79 of the third virtual node information acquisition processing described earlier with reference to FIG. 17. Then, the search program 61 terminates this fourth virtual node information acquisition processing.

On the other hand, if the search program 61 obtains a negative result in step SP82, it returns to step SP80. Then, the search program 61 repeats the same processing (from step SP80 to step SP82 and then back to step SP80).

Then, after completing the execution of the processing from step SP80 to step SP82 on all the pieces of node information retained by the virtualization environment management program 67, the search program 61 proceeds to step SP83, executes the processing from step SP83 to step SP102, and then terminates this fourth virtual node information acquisition processing.

### (3-3) Advantageous Effects of This Embodiment

According to this embodiment as described above, for example, it is possible to: acquire even the node information about a virtual server(s) 35 which is not managed by the virtualization environment management program 67 and the hypervisor 63; and reduce time required for the series of processing just like the first embodiment as compared to a conventional case where access to each of the IP addresses is tried sequentially according to a plurality of protocols. As a result, it is possible to realize a computer system capable of reducing node discovery time in the computer system with a large number of nodes and a large number of supported protocols.

### (4) Other Embodiments

Incidentally, the aforementioned first to third embodiments have described the case in which the search program 26, 52, 61 collects the node information about a plurality of nodes collectively from the successfully accessed physical server for virtual server 4, 62, virtualization environment management server 7, 66, management physical server 8, and hypervisor 63; however, the present invention is not limited to this example. If the search program 26, 52, 61 accesses a node which manages other nodes, it may collect the node information about the plurality of nodes collectively. Specifically speaking, the search program 26, 52, 61 may acquire the node information about other nodes when it accesses, for example, a DNS (Domain name system) server which creates an IP address from a domain name assigned to a node accessed on the IP network 9, a server existing on the network, an active directory server which manages, for example, hardware resources such as printers, a DHCP (Dynamic Host Configuration Protocol) server having necessary information to access the IP network such as a range of assignable IP addresses, or an LDAP (Lightweight Directory Access Protocol) server for managing information about mail addresses and environments of users who use the IP network 9, or a default gateway composed of equipment such as routers for network access to computers which do not exist on the same network.

Moreover, the aforementioned first to third embodiments have described the case in which the node information about each node in the computer system 1, 50, 60 is collected by trying access to the nodes sequentially according to predetermined protocols by using the registered authentication information in order with respect to IP addresses within an IP address range designated by the search program 26, 52, 61; however, the present invention is not limited to this example and the node information may be acquired by acquiring packets flowing through a management target node and analyzing the acquired packets. Specifically speaking, when the search program 26, 52, 61 accesses a network device, it acquires information such as a destination IP address, a destination port number, a source IP address, and a source port number by performing sniffing analysis of packets which pass through the network device. Consequently, it is possible to recognize that a node having an IP address which is the acquired destination IP address or the source IP address exists and is operating on the network. So, if the node information about nodes corresponding to the destination IP address and the source IP address acquired in the search result table 33, 54 does not exist, the search program 26, 52, 61 recognizes that a node search for this destination IP address and the source IP address has not been performed; and, therefore, the search program 26, 52, 61 may try access to the nodes corresponding to the destination IP address and the source IP address. Moreover, since it is possible to estimate what kind of OS is operating on the nodes having the destination port number and the source port number based on these port numbers acquired from the network device as a result of the sniffing analysis, the search program 26, 52, 61 may try access to the nodes according to a protocol which is predicted in advance.

Furthermore, the first to third embodiments have described the case where the search program 26, 52, 61 collects the node information about a plurality of nodes collectively from the successfully accessed physical server for virtual server 4, 62, virtualization environment management server 7, 66, management physical server 8, and hypervisor 63; however, the present invention is not limited to this example and the node information may be acquired based on network access history information about a management target node. Specifically speaking, the management server 2, 51 acquires the network access history information such as a list of nodes accessed by the target node, the status, IP addresses, and port numbers by sending nestat commands to OS's of the successfully accessed nodes. Then, the search program 26, 52, 61 may prioritize trying access to the nodes whose IP addresses are stored in this network access history information.

Furthermore, the aforementioned first to third embodiments have described the case in which the search program 26, 52, 61 collects the node information about each node in the computer system 1, 50, 60 by trying access to the nodes by sequentially using protocols stored in the supported protocol table 30 by using the registered authentication information in order with respect to IP addresses within a designated IP address range; however, the present invention is not limited to this example. For example, if accesses to nodes within a certain IP address range by using the same protocol have been continuously successful for a while, the search program 26, 52, 61 may prioritize using the protocol used last time for the next search.

Furthermore, the aforementioned first to third embodiments have described the case in which the search program 26, 52, 61 collects the node information about a plurality of nodes collectively from the successfully accessed physical server for virtual server 4, 62, virtualization environment management server 7, 66, management physical server 8, and hypervisor 63; however, the present invention is not limited to this example and, for example, the node information about the physical server for virtual server 4, 62, the virtualization environment management server 7, 66, the management physical server 8, and the hypervisor 37 may be registered in the management server 2, 51 in advance and the search program 26, 52, 61 may prioritize trying access to the nodes based on the registered node information.

Furthermore, the aforementioned first to third embodiments have described the case in which the search program 26, 52, 61 collects the node information about a plurality of nodes collectively from the successfully accessed physical server for virtual server 4, 62, virtualization environment management server 7, 66, management physical server 8, and hypervisor 63; however, the present invention is not limited to this example and the search program 26, 52, 61 may collect the node information by sending commands called PING (packet Internet Groper) to all addresses in the IP address range. Specifically speaking, the search program 26, 52, 61 may judge whether a node within the IP address range which is being accessed exists on the network or not, by sending data of approximately 32 bytes, which is called PING (packet Internet Groper), to all the addresses in the IP address range and diagnosing whether there is any response data or not; and if there is any response data, the search program 26, 52, 61 may prioritize trying access to a node with an IP address stored in the response data.

Furthermore, the aforementioned first to third embodiments have described the case in which the physical server for virtual server 4, 62, the virtualization environment management server 7, 66, the management physical server 8, and the hypervisor 37 manage node information (second information) such as configuration information (including IP addresses and OS types), performance information, and status information about a plurality of other nodes and the management server 2, 51 collects and manages IP addresses of management target nodes and communication protocol types to be used when communicating with the nodes; however, the present invention is not limited to this example and, for example, the management server 2, 51 may collect and manage node information (first information such as configuration information (including IP addresses and OS types), performance information, and status information from the physical server for virtual server 4, 62, the virtualization environment management server 7, 66, the management physical server 8, and the hypervisor 37 which are the management target nodes. Furthermore, the node information (the second information) about the physical server for virtual server 4, 62, the virtualization environment management server 7, 66, the management physical server 8, and the hypervisor 37 which are the management target nodes may retain the same configuration as that of the node information (the first information) about the management server 2, 51.

Furthermore, the aforementioned third embodiment has described the case where when the virtualization environment management program 67 and the hypervisor 37 replicate a virtual server 35 by means of cloning, they store information about a correspondence relationship between a virtual server ID of a replication source virtual server 35 and a virtual server ID of a replication destination virtual server 35 in the cloning relation tables 64, 68; however, the present invention is not limited to this example and, for example, the virtualization environment management program 67 and the hypervisor 37 may store node information such as configuration information (including IP addresses and OS types), performance information, and status information about the replication source virtual server 35 and the replication destination virtual server 35 respectively.

Furthermore, the aforementioned third embodiment has described the case where when the virtualization environment management program 67 and the hypervisor 37 create a virtual server 35 by using a template, they store information about a correspondence relationship between a template type ID of template type information and a virtual server ID of the virtual server 35 in the template virtual server relation tables 65, 69; however, the present invention is not limited to this example and, for example, the virtualization environment management program 67 and the hypervisor 37 may store specific configuration content of the template and node information such as configuration information (including the IP address and the OS type), performance information, and status information corresponding to the virtual server 35.

### INDUSTRIAL APPLICABILITY

The present invention can be applied to programs stored in the administrator's node for managing connected nodes in the network.

### REFERENCE SIGNS LIST

1, 50, 60 computer systems; 2, 51 management servers; 3 management terminal; 4, 62 physical server for virtual servers; 5 physical server; 7, 66 virtualization environment management servers; 8 management physical server; 9 network; 26, 52, 61 search programs; 30 supported protocol table; 31 authentication information table; 32 search candidate table; 33, 54 search result tables; 35 virtual server ; 37, 63 hypervisors; 39 virtualization environment management program; 64, 68 cloning relation tables; and 65, 69 template virtual server relation tables.

1. A computer system comprising:
a plurality of first nodes connected to a network;
one or more second nodes which are connected to the network and manage part or all of the plurality of first nodes; and
a management server which is connected to each of the first and second nodes via the network and collects and manages first information for each of the first and second nodes, including a network address of each of the first and second nodes and a protocol type of a communication protocol to be used when communicating with the first or second node,
wherein the second node manages second information including a network address of each management target first node among the plurality of first nodes and a protocol type of a communication protocol to be used when communicating with the first node, and
wherein when the management server searches the first and second nodes on the network and detects the second node, it acquires the network address of each of the first nodes managed by the second node and the protocol type of the communication protocol to be used when communicating with the first node, from the second node and manages the acquired network address and the acquired protocol type for each of the first nodes by associating them with each other.

2. A computer system according to claim 1,
wherein when the management server searches the first and second nodes and detects the first or second node, it acquires the protocol type of the communication protocol to be used when communicating with the first or second node and manages the acquired protocol type by associating it with the network address of the first or second node; on the other hand, when the management server detects the second node, it acquires the network address of each of the first nodes managed by the second node and the protocol type of the communication protocol to be used when communicating with the first node, from the second node and verifies whether the corresponding first node can be accessed or not, by using the acquired network address and the acquired protocol type.

3. A computer system according to claim 1,
wherein when the first node is created by replicating another first node, the second node retains first relationship information indicating a correspondence relationship between the first node which is a replication source and the first node which is a replication destination, and
wherein the management server acquires the protocol type of the communication protocol for the first node replicated from the other first node by using the first relationship information and tries access to the first node, which is a target, by prioritizing the acquired protocol type.

4. A computer system according to claim 1,
wherein when the first node is created based on a template, the second node retains second relationship information indicating a correspondence relationship between the template and the first node created based on the template, and
wherein the management server acquires the protocol type of the communication protocol for the first node replicated from the other first node by using the second relationship information and tries access to the first node, which is a target, by prioritizing the acquired protocol type.

5. A computer system according to claim 1,
wherein the management server manages the network address of the second node in advance, and
wherein when searching the first and second nodes on the network, the management server prioritizes searching of the second node corresponding to the network address.

6. A computer system according to claim 1,
wherein when searching the first and second nodes on the network, the management server acquires the protocol type of the communication protocol to be used to access the first or second node detected by the search by executing trial processing for trying access sequentially to the detected first or second node by using a plurality of protocol types supported by the management server, and
wherein the trial processing is executed to try access to the first or second node, which is a target, by prioritizing the protocol type acquired for the first or second node detected last time.

7. A node search method for a computer system including:
a plurality of first nodes connected to a network;
one or more second nodes which are connected to the network and manage part or all of the plurality of first nodes; and
a management server which is connected to each of the first and second nodes via the network and collects and manages first information for each of the first and second nodes, including a network address of each of the first and second nodes and a protocol type of a communication protocol to be used when communicating with the first or second node,
wherein the second node manages second information including a network address of each management target first node among the plurality of first nodes and a protocol type of a communication protocol to be used when communicating with the first node,
the node search method comprising:
a first step executed by the management server searching the first and second nodes on the network; and
a second step executed by the management server, when detecting the second node, acquiring the network address of each of the first nodes managed by the second node and the protocol type of the communication protocol to be used when communicating with the first node, from the second node and managing the acquired network address and the acquired protocol type for each of the first nodes by associating them with each other.

8. A node search method according to claim 7,
wherein when the management server detects the first or second node in the first step, it acquires the protocol type of the communication protocol to be used when communicating with the first or second node and manages the acquired protocol type by associating it with the network address of the first or second node, and
wherein in the second step, the management server verifies whether the corresponding first node can be accessed or not, by using the network address and the protocol type of each of the first nodes acquired from the second node and managed by the second node.

9. A node search method according to claim 7,
wherein when the first node is created by replicating another first node, the second node retains first relationship information indicating a correspondence relationship between the first node which is a replication source and the first node which is a replication destination, and
wherein in the second step, the management server acquires the protocol type of the communication protocol for the first node replicated from the other first node by using the first relationship information and tries access to the first node, which is a target, by prioritizing the acquired protocol type.

10. A node search method according to claim 7,
wherein when the first node is created based on a template, the second node retains second relationship information indicating a correspondence relationship between the template and the first node created based on the template, and
wherein in the second step, the management server acquires the protocol type of the communication protocol for the first node replicated from the other first node by using the second relationship information and tries access to the first node, which is a target, by prioritizing the acquired protocol type.

11. A node search method according to claim 7,
wherein in the first step, the management server manages the network address of the second node in advance, and
wherein when searching the first and second nodes on the network, the management server prioritizes searching of the second node corresponding to the network address.

12. A node search method according to claim 7,
wherein when searching the first and second nodes on the network in the first step, the management server acquires the protocol type of the communication protocol to be used to access the first or second node detected by the search by executing trial processing for trying access sequentially to the detected first or second node by using a plurality of protocol types supported by the management server, and
wherein the trial processing is executed to try access to the first or second node, which is a target, by prioritizing the protocol type acquired for the first or second node detected last time.
